(19) United States
(12) Patent Application Publication
(10) Pub. No.: US 2021/0256611 A1
(43) Pub. Date: Aug. 19, 2021

(54) APPARATUS AND METHOD FOR GENERATING AND VALIDATING CUSTOMIZED INVESTMENT PORTFOLIOS

(71) Applicant: ASSETPLUS INVESTMENT MANAGEMENT CO., LTD., Seongnam-si (KR)

(72) Inventors: Joo Sung PARK, Yongin-si (KR); Yong Je LEE, Seoul (KR); Sun SHIN, Seoul (KR)

(73) Assignee: ASSETPLUS INVESTMENT MANAGEMENT CO., LTD., Seongnam-si (KR)

(21) Appl. No.: 16/828,087

(22) Filed: Mar. 24, 2020

(30) Foreign Application Priority Data
Feb. 19, 2020 (KR) 10-2020-0020674

(51) Int. Cl. G06Q 40/06; G06F 16/9535; G06F 40/295

(52) U.S. Cl. CPC G06Q 40/06; G06F 40/295; G06F 16/9535

(57) ABSTRACT

A method for generating and validating customized investment portfolios according to an example of the present invention includes (a) a step of receiving an investment idea from a user terminal; (b) a step of selecting an investment product corresponding to the investment idea, and selecting an asset investment ratio distribution method for each investment product to generate the investment portfolio; (c) a step of validating risk and profitability of the investment portfolio in accordance with a past period and predetermined criteria, and providing generation results and validation results of the investment portfolio to the user terminal; and (d) a step of setting the investment portfolio to be exposed to another user terminal connected to the server in accordance with a request of the user terminal.

### CROSS-REFERENCE TO RELATED APPLICATION

This application claims priority to and the benefit of Korean Patent Application No. 10-2020-0020674 filed in the Korean Intellectual Property Office on Feb. 19, 2020, the entire contents of which are incorporated herein by reference.

### BACKGROUND OF THE INVENTION

The present invention relates to an apparatus and a method for selecting an investment product corresponding to an idea based on an investment idea of a user, and validating risk and profitability of a selected investment product to be shared with other users.

Making and managing money are forever what we need in our lives. There are many different ways to make and manage money well, and the ways continually change in a variety of circumstances, including changing in times and changing in markets. In such diversity and changes, there are many people who read the values of that era and talents thereof, and many people who want to manage their assets well need the talents.

However, the changes in the era occur in a wide variety of areas and fluctuate rapidly, and a response pace of institutional asset management services or consignment asset managers is unable to keep up with a pace of the change. There is a need for a platform that instantly implements investment strategies/investment ideas of people who have the talents of reading the changing value of the era in accordance with various requirements.

### SUMMARY OF THE INVENTION

In order to solve the problems described above, an object of the present invention is to construct a detailed investment product or an investment portfolio only for a user thereof by only using an arbitrary investment idea of the user with respect to an asset investment received from a user terminal.

In addition, another object thereof is to create an environment in which risk and profitability of the selected investment product is validated, and the calculated investment product is shared with other users.

In addition, further another object thereof is to connect a fund producer to a fund consumer (asset management needs) based on a database that efficiently collects and refines a wide range of data including a large number of structured and unstructured assets available for investment, and standardized big data.

According to an example of the present invention for solving the technical problems described above, there may be provided a method for generating and validating customized investment portfolios, which is executed by a server, the method may include: (a) a step of receiving an investment idea from a user terminal; (b) a step of selecting an investment product corresponding to the investment idea, and selecting an asset investment ratio distribution method for each investment product to generate the investment portfolio; (c) a step of validating risk and profitability of the investment portfolio in accordance with a past period and predetermined criteria, and providing generation results and validation results of the investment portfolio to the user terminal; and (d) a step of setting the investment portfolio to be exposed to another user terminal connected to the server in accordance with a request of the user terminal.

In addition, prior to the step (a), an investment idea receiving interface for receiving the investment idea may be provided to the user terminal, and the investment idea may be received by the investment idea receiving interface, through any one of an option method of giving options for the investment idea, a text input method of directly inputting a text by the user, and a text input method based on voice recognition through a microphone of the user.

In addition, when the investment idea receiving interface is implemented through the text input method, in the step (a), key words for calculating the investment portfolio may be extracted from a plurality of texts input by the user terminal, and whether or not the key words meet predetermined requirements for selecting a country, a type, and an item name of the investment product may be determined from the investment idea, and if there are insufficient requirements, the insufficient requirements may be provided to the user terminal to receive an additional text.

In addition, the step (b) may include (b-1) a step of searching for the investment product corresponding to the investment idea, (b-2) a step of removing and filtering the investment product that is determined not to meet the investment idea based on predetermined criteria, among the investment products as a result of the search, and (b-3) a step of setting the asset investment ratio distribution method for the filtered investment product.

In addition, in the step (b-1), predetermined key words for searching for the investment product may be extracted from the investment idea and calculating the investment product that matches the key words.

In addition, in the step (b-2), the investment product may be excluded in which one or more of a divided ratio to a deficit and a profit ratio of equity to a market average of the investment products is lower than a predetermined value.

In addition, in the step (b-3), the investment portfolio may be completed by setting a ratio distribution method of the investment assets based on predetermined criteria, among the investment products.

In addition, in the step (b-3), the distribution ratio of the investment assets that yield an optimal profit ratio, among the investment products included in the investment portfolio, may be set through predetermined artificial intelligence.

In addition, the step (c) may include (c-1) a step of quantitatively analyzing the investment portfolio in a past period designated by the user, (c-2) a step of executing a characteristic analysis of the investment portfolio in accordance with predetermined criteria, and (c-3) a step of validating the risk and profitability of the investment portfolio.

In addition, prior to the step (c-1), the past period for validating the risk and profitability may be received from the user terminal, and in the step (c-1), a quantitative result value may be calculated by applying the past period to the investment portfolio.

In addition, in the step (c-2), a predetermined result value for the characteristic analysis of the investment portfolio may be calculated, and the predetermined result value may use, as a result value, at least one or more of a value analysis, a profit indicator, a growth indicator, an activity indicator, a safety indicator, a dividend indicator, a price indicator, a separation degree, and a technical analysis indicator of the investment products.

In addition, in the step (c-3), the stability and profitability of the investment portfolio may be determined to be low when the result of the quantitative analysis calculated in the step (c-1) has a variability of a predetermined value or more, or when the quantitative indicator matching the item of the investment product constituting the investment portfolio is the predetermined value or less.

In addition, the step (c-1) to step (c-3) may be performed regardless of the order or performed simultaneously.

In addition, prior to the step (d), personal information of the user further may be received from the user terminal, and in the step (d), the investment portfolio may be shared with another user terminal registered with other personal information having similarity of a predetermined value or less with the personal information, and the personal information may be information including at least one or more of a user's gender, an age, a place of residence, a hobby, interests, a size of assets, an interest investment product, and a type of invested product in the current investment.

In addition, in the step (d), a predetermined ratio to the costs used for the purchase may be provided to the user terminal that registered the investment idea, when the other user terminal purchases the investment portfolio.

In addition, in an apparatus for generating and validating customized investment portfolios, the apparatus includes a memory in which a program for providing a method for generating and validating customized investment portfolios is stored; and a processor that provides the method for generating and validating customized investment portfolios by executing the program stored in the memory. The processor sets such that an investment idea a is received from a user terminal; an investment product corresponding to the investment idea is selected, and an asset investment ratio distribution method is selected for each investment product to generate the investment portfolio; and risk and profitability of the portfolio are validated in accordance with a past period and predetermined criteria, and generation results and validation results of the investment portfolio to the user terminal are provided; and the investment portfolio is set to be exposed to another user terminal connected to the server in accordance with a request of the user terminal.

In addition, a computer-readable storage medium stores a program for executing the method for generating and validating customized investment portfolios, the program being executed by the server described above.

According to an example of the present invention, it is possible to select the investment product based on the investment idea for the investment asset received from the user terminal.

In addition, the risk and profitability of the selected investment product are validated, and an environment is created in which the calculated investment product is shared with other users.

In addition, it is possible to provide the service in which a fund (investment product) producer is connected to a fund consumer (asset management needs) based on a database that efficiently collects and refines a wide range of data including a large number of structured and unstructured assets available for investment, and standardized big data.

In addition, according to the present invention, the fund creator can easily and conveniently make the investment strategy/idea owned by himself/herself the fund. In other words, the insights of the era can meet the big data and the AI technology provided by the platform, thereby being implemented in the form of the funds, and being shared and distributed with and to many people.

This allows the creator of the fund having talents satisfies the demands (needs) of various people for the asset management. Therefore, the creator can create the profit and express the talents, which he/she didn't know, for the investment and asset management.

In addition, according to the present invention, in the view point of the fund consumer, the investment strategy/idea desired by the fund consumer can be recommended easily and quickly, among the investment strategies/ideas of unspecified multiple fund creators.

In addition, technologies that can help for finding the funds, the fund consumer want, in a number of investment strategies/ideas are provided through a fund classification and a relative superiority determination service by classification in consistent fund analysis services and diverse standards, based on quantitative and objective data. This allows the fund consumer to receive the service of inexpensive funds which are not experienced in the existing fund market, funds which immediately reflect changes in the current era, funds which continue to be well managed and do not change over time, and funds which are not distorted by the seller's distorted subjectivity.

### BRIEF DESCRIPTION OF THE DRAWINGS

FIG. 1 is a view illustrating a configuration of a system for generating and validating customized investment portfolios according to an example of the present invention.

FIG. 2 is a diagram illustrating a configuration of a server 100 according to an example of the present invention.

FIG. 3 is a flowchart illustrating a method for generating and validating customized investment portfolios according to an example of the present invention.

FIG. 4 is a flowchart illustrating a process of generating an investment portfolio according to an example of the present invention.

FIG. 5 is a flowchart illustrating a process of validating risk and profitability of the investment portfolio according to an example of the present invention. FIG. 1 is a schematic flowchart of a method for producing a graphene ink composition according to one example of the present invention.

### DETAILED DESCRIPTION OF THE EMBODIMENT

Hereinafter, examples of the present invention will be described in detail with reference to the accompanying drawings so that those skilled in the art may easily implement the present invention. However, the present invention may be embedded in many different forms and is not limited to the examples demonstrated here. In the drawings, portions irrelevant to the description are omitted for simplicity of explanation, and like reference numerals designate like portions throughout the specification.

Throughout the specification, when a portion is “connected” to another portion, this includes not only “directly connected” but also “electrically connected” to another portion with another element interposed therebetween. In addition, when a portion is said to “include” a certain component, which means that it may further include other components, without excluding the other components, unless specifically stated otherwise. It should be understood that it does not exclude in advance a possibility of the presence or addition of one or more other features, numbers, steps, operations, configuration elements, partial components, or a combination thereof.

The following examples are detailed description to aid in understanding the present invention, and do not limit the scope of the present invention. Therefore, the same range of inventions that perform the same functions as those of the present invention will also fall within the scope of the present invention.

Throughout the specification, a server 100 may refer to an apparatus for generating and validating a customized investment portfolio.

In addition, in the entire specification, the investment products refer to products such as stocks, funds, and derivatives, and items may correspond to classifications regarding contents and forms of securities that are subject to trading transactions in the securities market. For example, if the investment product is the stock, the Samsung Electronics' stock is the item.

In more detail, hereinafter, the “investment product” may be a concept encompassing stocks, derivatives, and real products, and financial products linked to an index based thereon. The “investment product” may take a form of the investment portfolio constituted of several financial products. In this case, the securities include equity securities (that is, the “stocks” commonly used in society), collective investment schemes (CIS), equity linked securities (ELS), and exchange-traded funds (ETF). The equity securities invests to a company's capital and may mean a product that temporarily owns the company and invests to obtain stock gains or dividends from stock trading. Equity securities may be stocks received by investing funds in joint stock companies or equity investments obtained by investing in limited companies or the like. In addition, the ETF is a type of fund-like product, which means an index product designed to be freely traded like the stocks by listing a price calculated by constituting the portfolio that mimics the specific index. The derivatives may be financial products whose values are determined by the price of another asset. The main purpose of using the derivatives is to avoid the risk of change in the values of underlying assets such as grain, crude oil, gold, stocks, and bonds due to market fluctuations, such as unexpected interest ratios, exchange ratios, and stock price fluctuations. The underlying assets, to which the values of the derivatives are linked, are called the spots, and representative derivatives may include forwards, futures, options, swaps, and the like.

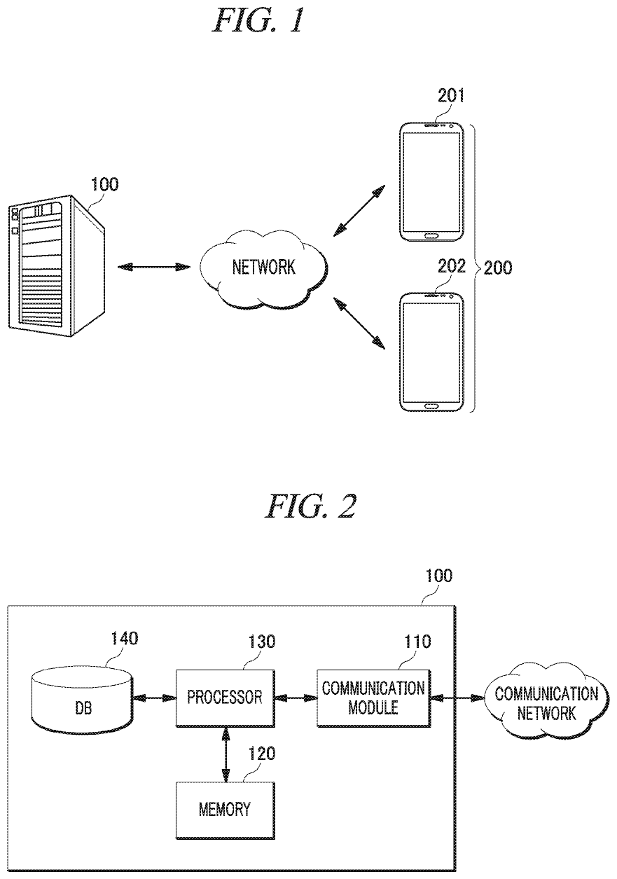

FIG. 1 is a view illustrating a configuration of a system for generating and validating customized investment portfolios according to an example of the present invention.

Referring to FIG. 1, according to an example of the present invention, the system may include the server 100 and a plurality of user terminals 200. In this case, although not illustrated in the drawings, respective apparatuses may be interconnected by wire or wirelessly through a communication network.

According to an example of the present invention, the server 100 receives an investment idea from a specific user terminal 201, selects an investment product corresponding to the investment idea, and then selects an asset investment ratio distribution method for each investment product to generate the investment portfolio. Here, although only one server 100 is illustrated in the drawing, functions performed by one server 100 may be divided into a plurality of servers and are performed thereby. Hereinafter, for convenience, it will be described on the assumption that all functions are performed in one server 100.

In this case, the investment idea may mean idea information on the investment that the user has. In this case, the investment idea may be delivered to the server 100 in various methods, such as a syntax input method, a voice input method, and an option selection method. The server 100 may select an asset having a value/relative advantage among various investment assets through the investment idea input by the user terminal 200.

The server 100 validates the risk and profitability of the generated investment portfolio by using the past period and predetermined criteria, and provides generation results and validation results of the investment portfolio to the specific user terminal 201.

In addition, in response to a request of the specific user terminal 201, the server 100 may set the investment portfolio to be exposed to another user terminal 202 connected to the server 100. Therefore, the other user terminal 202 is able to purchase the investment portfolio.

According to an example of the present invention, the server 100 generates the investment portfolio by selecting the investment product based on the investment idea received from the user terminal 200, validates the risk and profitability of the generated investment portfolio, and then provides the generated investment portfolio to the user terminal 200.

In addition, the investment portfolio in which the risk and profitability are validated is shared with the other user terminal 202. Therefore, when the other user terminal 202 purchases the investment products included in the investment portfolio, a part of the purchase cost is provided to the user terminal 201 which provides the investment idea for generating the investment portfolio.

The user terminal 200 may refer to terminals of users using the service for generating and validating the customized investment portfolio.

The user terminal 200 transmits the investment idea to the server 100 and receives the investment portfolio corresponding thereto and the risk and profitability of the investment portfolio.

In addition, when the investment portfolio is sold to the other user terminal 202, a part of the selling cost may be provided.

In this case, the application for generating and validating the customized investment portfolio to the user terminal 200 may be an application embedded in the user terminal 200 or an application downloaded from an application distribution server and installed in the user terminal 200.

In addition, the user terminal 200 refers to a communication terminal that can use the terminal application in a wired or wireless communication environment. Here, the user terminal 200 may be a portable terminal of the user. In FIG. 1, although the user terminal 200 is illustrated as a smart phone, which is a type of portable terminal, the spirit of the present invention is not limited thereto. As described above, a terminal capable of mounting the terminal application may be borrowed without limitation.

In more detail, the user terminal 200 may include a handheld computing device (for example, PDA, email client, or the like), any form of cellular phone, or any form of another type of computing or communication platform. However, the present invention is not limited thereto.

On the other hand, the communication network serves to connect the server 100 and the user terminal 200. That is, the communication network refers to a communication network that provides an access path so that the user terminal 200 can transmit and receive data after connecting to the server 100. The communication network may be a wired networks such as local area networks (LANs), wide area networks (WANs), metropolitan area networks (MANs), and integrated service digital networks (ISDNs), or wireless networks such as wireless LANs, CDMA, Bluetooth, and satellite communication. However, the scope of the present invention is not limited thereto.

FIG. 2 is a diagram illustrating a configuration of the server 100 according to an example of the present invention.

With reference to FIG. 2, the main server 100 according to an example of the present invention includes a communication module 110, a memory 120, a processor 130, and a database 140. In detail, the communication module 110 provides a communication interface necessary for providing a transmission/reception signal between the server 100 and the user terminal 200 in the form of packet data in association with a communication network. In addition, the communication module 110 may receive a data request from the user terminal 200 and transmit data in response thereto.

Here, the communication module 110 may be a device including hardware and software necessary for transmitting and receiving a signal such as a control signal or a data signal through a wired or wireless connection with another network device.

The memory 120 records a program for generating and validating the customized investment portfolio to the user terminal 200. In addition, the memory 120 performs a function of temporarily or permanently storing data processed by the processor 130. Here, the memory 120 may include a magnetic storage media or a flash storage media, but the scope of the present invention is not limited thereto.

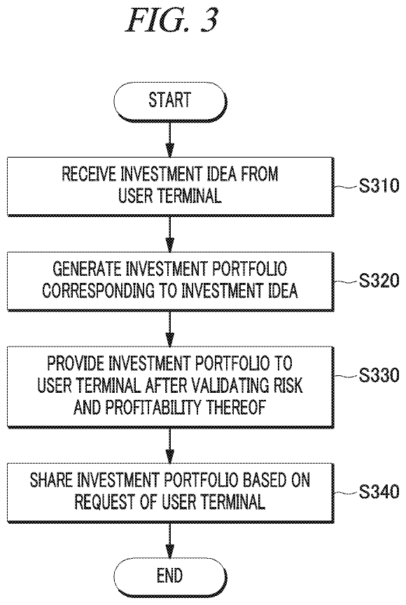

The processor 130 is a type of central processing unit that controls the entire process of generating and validating the customized investment portfolio. Each step performed by the processor 130 will be described later with reference to FIGS. 3 to 5.

Here, the processor 130 may include all types of devices capable of processing data, such as a processor. Here, the ‘processor’ may refer to a data processing device embedded in hardware having, for example, a circuit physically structured to perform a function represented by a code or instructions included in a program. As an example of the data processing device embedded in hardware, a microprocessor, a central processing unit (CPU), a processor core, a multiprocessor, and an application-specific integrated circuit (ASIC), a field programmable gate array (FPGA), or the like, but the scope of the present invention is not limited thereto.

The database 140 may store the investment idea presented by the user terminal 200 and the investment portfolio corresponding thereto. In addition, when the investment idea is stored, information on the user capable of confirming who presented the investment idea may be further stored.

Although not illustrated in FIG. 2, some of the data for the investment idea and investment portfolio may be stored in a database (not illustrated) that is physically or conceptually separated from the database 140.

In an alternative example, the database 140 may separately store big data for artificial intelligence learning for the server 100 to recommend the investment products based on the investment idea. For example, various unstructured data (for example, information or keywords themselves extracted from the text about investments uploaded by users on the Internet or on social networks) such as keyword information and road congestion used by people in the relevant time zone, including various structured data (for example, stock data, fund data, derivatives, and the like published on the Internet) that are traded on the relevant market, may be stored as big data. This information can be used to create investment products and provide a basis for users to easily implement the investment idea. Secondary processed data obtained by reprocessing or analyzing data can also be used as big data for learning data. In this case, the collection method of the big data may be supplied through a data provider, or all technical collection methods such as public data collection, open source data crawling, API, and the like may be used.

In another alternative example, the database 140 may store results obtained by implementing and analyzing investment strategy ideas. For example, results obtained by analyzing the investment idea, and analyzing subscription investment product of the user, which is used in the analysis, and the generated investment product may be stored. This data can be used to manage the analysis results and history of the investment products that the producers and the consumers of the investment products generate or subscribe.

In further another alternative example, the database 140 may store and manage information on the investment product finally published in the investment product trading service. Through this, the server 100 automatically defines and manages various calculation results of the investment products according to the analysis results such as characteristics, attributes, values, prices, themes, events, emotional analysis results and macro analysis results for the investment ideas.

In addition, the server 100 may manage the investment product by the hash tag or the like specified by the producer to the investment product.

In further another alternative example, the database 140 may store community contents that are freely recorded by the user who uses the service. In this case, the contents may mean a text, a video, an audio, a link, an image, and the like, and may also be used as data for learning an algorithm by storing the result of the investment product (or the investment idea) analyzed based on the relevant contents.

In addition, although not illustrated in the drawings, an investment idea receiving module for receiving the investment ideas, an investment item selection module for selecting the investment products, a filtering module for removing assets that hinder the calculation of investment products pursued by the investment idea, an investment asset distribution module for setting a distribution criteria of the investment assets, a performance analysis module for analyzing the performance of the calculated investment portfolio, a characteristic analysis module, and an effectiveness validation module may be further included.

FIG. 3 is a flowchart illustrating a method for generating and validating customized investment portfolios according to an example of the present invention.

Referring to FIG. 3, according to an example of the present invention, the server 100 receives the investment idea from the user terminal 200 (S310).

Prior to step S310, the server 100 may provide an investment idea receiving interface for receiving the investment idea to the user terminal 200.

In this case, the investment idea receiving interface may be implemented by any one of the following methods.

First, the investment idea receiving interface may be implemented in a method of giving options for investment ideas. For example, the server 100 sequentially provides an option for calculating the investment asset, such as an option for selecting the country, an option for the type or the item of the investment products, to the user terminal 200. In addition, information, such as whether the company is a growing company or a mature company and whether the company's main technology is IT or bio, may also be provided as the option.

Next, the investment idea receiving interface may be implemented as a text input method that can be directly input by the user or a text input method based on voice recognition. When such a method is implemented, in step S310, the server 100 extracts the key words for calculating the investment portfolio from a plurality of texts input by the user terminal 200, and determines whether the key words meet the predetermined requirements for selecting the country, the type, and the item name of the investment product from the investment idea.

In detail, the user inputs, through the investment idea receiving interface, the types of investment products (stocks, funds, bonds, and the like), the countries, the objects (preferred stocks, large stocks, and the like), financial item criteria, factor criteria (size, value, quality, low volatility, dividends, and the like), interest criteria, industry criteria, sector criteria, theme criteria, regional criteria, emotional dictionary criteria, issue criteria, size criteria, value attribute criteria, price attribute criteria, technical analysis criteria, value analysis criteria, criteria and ranges of various distribution methods, investment performing points, and the like.

In this case, the investment idea receiving interface must provide the guide so that at least some information such as the types of investment products, the countries, and the subjects (preferred stocks, large stocks, and the like) can be input.

For example, when the server 100 receives an investment idea of “making investment products for U.S company stocks with high dividend yields”, the server 100 calculates and uses the key words of the dividend yields. U.S, and company.

In a further example, the key words extracted from the investment idea previously received and used from the other user terminal 202 having a predetermined similarity with the investment idea input by the user terminal 201 may be used.

If there are insufficient requirements in the key words extracted from the investment idea, the server 100 provides the insufficient requirements to the user terminal 200 and further provides an additional text.

Next, the server 100 generates the investment portfolio corresponding to the investment idea (S320).

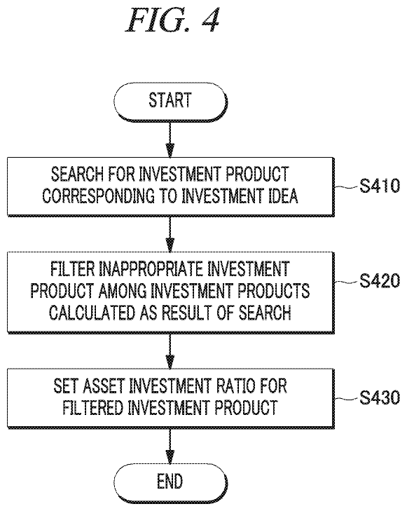

At this time, the process of selecting the investment product to be performed by the server 100 in step S320 will be described in more detail with reference to FIG. 4.

Next, after validating the risk and profitability of the investment portfolio, the server 100 provides the investment portfolio and the result values of the validation to the user terminal 200 (S330).

The algorithm used for validating the investment portfolio in step S330 is an algorithm generated by the investment product producer and refers to an algorithm for performing validation before the generated investment products are published to the consumer.

The profitability of the investment products generated by the investment ideas can be quantitatively analyzed through the performance analysis algorithm. At this time, the performance analysis algorithm illustrates the past performance of the investment and can analyze the peculiarities of the time-specificity of performance and the quality of overall performance.

In addition, through the characteristic analysis algorithm, the characteristics are analyzed based on predetermined criteria in terms of each development investment product selected as the investment portfolio, and the results thereof are calculated.

In addition, an investment product stability validation algorithm for checking whether the investment ideas undermine fundamental stability and a unique fund validation algorithm for checking whether the created investment product is different from other published investment products may be used.

For example, the investment product stability validation algorithm requests to re-adjust the investment idea when testing results cause excessive volatility, when bias due to under/over-selection of the investment items occurs, when the figures, such as quantitative indicators that match the pursued investment idea are a predetermined average or less, and when the similarity with the existing investment portfolio is high (contrary, when the exclusivity is low).

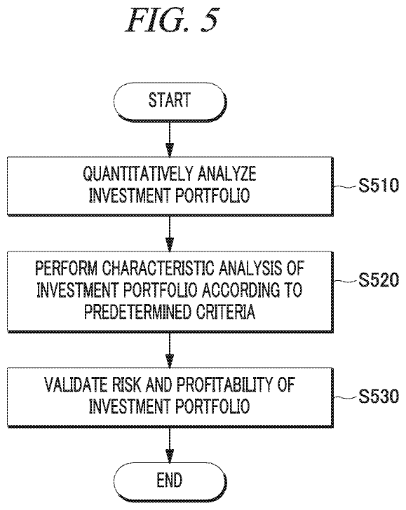

At this time, in step S330, the process of validating the stability and profitability of the investment portfolio that is performed by the server 100 will be described in more detail with reference to FIG. 5 which is described later.

Finally, the server 100 shares the investment portfolio to the other user terminal 200 based on the request of the user terminal 200 (S340).

Prior to step S340, the server 100 may further receive personal information of the user from the user terminal 200.

In this case, the personal information may refer to information including at least one or more of a user's gender, age, place of residence, hobby, interest, size of asset, interest investment product, and a type of investment product currently invested.

In step S340, the server 100 may expose the investment portfolio to other user terminal 202 registered with other personal information having similarity of a predetermined value or less with the personal information so as to induce sharing.

That is, the server 100 classifies investment tendencies based on user's personal information and preferentially provides a preferred strategy in the process of selecting the investment strategy, or provides services based on preference in recommendation investment product matching service or investment product trading service.

In this case, the personal information may be a user's gender, age, place of residence, hobby, interests, interest investment products, owned products, and types of invested products, owned assets, and the like.

In this case, when the other user terminal 202 purchases the investment portfolio, a predetermined ratio to the costs used for the purchase may be provided to the user terminal 200 that registered the investment idea.

Therefore, even if many users share their investment ideas, it is possible to implement the service that may not lose.

FIG. 4 is a flowchart illustrating a process of generating the investment portfolio according to an example of the present invention.

Referring to FIG. 4, according to an example of the present invention, the server 100 searches for the investment product corresponding to the investment idea (S410).

In operation S410, the server 100 extracts predetermined key words for searching for the investment product from the investment idea and calculates the investment product that matches the key words.

If it is impossible to extract sufficient key words to calculate the investment product, as described above, the input for the key words is requested prior to step S420.

Next, the server 100 filters out an inappropriate investment product among the investment products calculated as a result of the search (S420).

This means an operation of removing and filtering the investment product that is determined not to meet the investment idea based on predetermined criteria, among the investment products calculated as a result of the search performed in step S410.

For example, in step S420, the server 100 excludes, to perform filtering, the investment product of the company in which one or more of the dividend ratio to the deficit and the profit ratio of equity to the market average of the investment products is lower than a predetermined value, or the volatility of the dividend is large.

Finally, the server 100 sets the asset investment ratio distribution method for the filtered investment product (S430).

In step S430, the server 100 may simply complete the investment portfolio by setting the distribution ratio of the investment assets based on predetermined criteria, among the investment products.

For example, in order to increase the stability of the funds, the investment assets can be determined by a specific weight for the screened items. The distribution ratio of the assets is determined by simple filtering that takes into account a condition that prevents the investment weight of items that constitute the investment products from being excessively set to a predetermined level or more; a condition that prevents the investment assets from being excessively concentrated on a particular item; a condition of the ratio that the same type of items do not exceed a predetermined ratio to the entire items; a condition that trading costs or trading opportunity costs is prevented from being excessive in consideration of the trading costs; a condition that prevent a sector or a region from being excessively grouped against the market weight; a condition such as the minimum transfer weight, the minimum transfer number, and the like.

However, the server 100 may set the distribution ratio of the investment assets that yield an optimal profit ratio, among the investment products included in the investment portfolio through predetermined artificial intelligence.

For example, the artificial intelligence can be used to determine the distribution and weight of the investment assets by performing learning for maximizing the targets of pursuing investment strategies while maintaining the stability of the investment products. That is, a learning model can be constructed and used to predict whether the maximum profit is generated in a case where how much of each investment asset is allocated in a state where specific items are determined. The maximum profit ratio is tracked while constantly changing the allocation weight of the investment assets.

FIG. 5 is a flowchart illustrating a process of validating the risk and profitability of the investment portfolio according to an example of the present invention.

Referring to FIG. 5, according to an example of the present invention, the server 100 quantitatively analyzes the investment portfolio (S510).

Prior to step S510, the server 100 receives a past period for validating the risk and profitability from the user terminal 200.

Thereafter, in step S510, the server 100 calculates a quantitative result value by applying the past period to the investment portfolio.

At this time, the server 100 provides the user terminal 200 with the calculated quantitative result value (for example, a profit indicator, a risk indicator, a price indicator, fundamental information, trading history information for each trading point, or the like). Therefore, the user determines the profitability and stability of his/her investment portfolio. In addition, in an alternative example, the server 100 may provide the result values which are graphically or statistically tabled in easy expression methods such as a graph, a table, and a numerical value to help users to understand the result values.

In addition, the server 100 may provide the quantitative value, in text, analyzing the quality of the singularity or the overall performance at a specific time included in a designated section.

Therefore, the server 100 performs the characteristic analysis of the investment portfolio in accordance with predetermined criteria (S520).

In step S520, the server 100 calculates a predetermined result value for analyzing the investment portfolio.

At this time, the predetermined result value may use, as the result value, at least one or more of a value analysis, a profit indicator, a growth indicator, an activity indicator, a safety indicator, a dividend indicator, a price indicator, a separation degree, and a technical investment indicator.

In detail, the value analysis performs a spatial or time series analysis of the value indicator. In the case of the profit indicator, information on profit ratios such as an operating profit ratio, a net profit ratio, a total asset profit ratio, and a capital profit ratio is analyzed. In the case of the growth indicator, various profit growth ratios such as a sales growth ratio, a total capital growth ratio, a net profit growth ratio, and an operating profit growth ratio are analyzed. In the case of the activity indicator, capital turnover ratios such as an equity turnover ratio, a total asset turnover ratio, and a tangible asset turnover ratio are analyzed. In the case of the safety indicator, safety ratios such as a debt ratio, a borrowing dependence degree, an interest compensation ratio, a quick ratio, and a current ratio are analyzed. In the case of the dividend indicator, indicators on dividend and dividend yield such as a dividend yield ratio, a dividend tendency, a dividend growth ratio, a retention ratio, and an increase ratio of retention. In the case of the separation degree, the separation degree indicator such as a relative separation degree and an absolute separation degree, and a distribution of the separation degree are analyzed. The technical analysis indicator uses various trends and technical indicators such as a resistance line, a support line, a MACD, and a golden/death cross.

In an alternative example, the server 100 may provide a function of selecting two or more single characteristics among the above-listed characteristics and simultaneously comparing them in the same matrix.

For example, all the analysis indicators such as the value, price, and dividend indicators listed by the user are designated irrelevant to X and Y axes. Values corresponding to the designated indicators among attributes of the generated investment products are projected on the X and Y axes, respectively, to provide the user terminal 200 with a graph or table for the two indicators.

Using such a method, the server 100 can analyze the distribution status according to various classification criteria such as the weight of individual investment asset, the weight of the sector, the weight of the region, the weight of the style, the weight of the size, and the concentration degree analysis on the investment portfolio.

Finally, the server 100 validates the risk and profitability (effectiveness) of the investment portfolio (S530).

When the result of the quantitative analysis calculated in step S510 has a variability of a predetermined value or more, or when the quantitative indicator matching the item of the investment product constituting the investment portfolio is the predetermined value or less, the server 100 determines that the stability and profitability of the investment portfolio are low.

In addition, the server 100 may check whether the generated investment portfolio impairs the basic stability.

For example, when following the testing result performed in step S510, if it falls in a case where it is determined that the profit ratio of the investment product causes the excessive volatility; a case where it is determined that any one of the items included in the investment portfolio is considered to be biased due to under/over selection; or a case where the value of the quantitative indicator that matches the item constituting the generated investment products is an average value or less, the server 100 determines that the investment portfolio is deteriorating the stability, the user terminal 200 may require readjustment of the investment ideas.

In another alternative example, the server 100 may validate whether the generated investment portfolio is different from other investment portfolios that have been previously generated and published for everyone to see within the existing platform. For example, by comparing an attribute value (which may mean the type of the investment product, the item, and the asset distribution ratio) of the investment product of another user generated by the other user terminal 202 with an attribute value of the investment portfolio generated through the user terminal 200, it is determined that there is a difference when the attribute value exceeds a predetermined level.

In an alternative example, the processes of steps S510 to S530 may be performed regardless of the order or may be performed simultaneously.

In an additional example, the user terminal 200 subscribed to the premium service may receive the trend of the investment portfolios, as statistics, generated by the other user terminal 202 using the service. This allows the user to determine whether his/her investment portfolio corresponds to the current trends or to get information on the latest trends.

The foregoing description of the present invention is intended for illustration, and it will be understood by those skilled in the art that the present invention may be easily modified in other specific forms without changing the technical spirit or essential features of the present invention. Therefore, it should be understood that the examples described above are exemplary in all respects and not restrictive. For example, each component described as a single type may be implemented by being dispersed, and similarly, components described as being dispersed may be implemented in a combined form.

The scope of the present invention is illustrated by the following claims rather than the above description, and all changes or modifications derived from the meaning and scope of the claims and their equivalents should be construed as being included in the scope of the present invention.

What is claimed is:

1. A method for generating and validating customized investment portfolios, which is executed by a server, the method comprising:
(a) a step of receiving an investment idea from a user terminal;
(b) a step of selecting an investment product corresponding to the investment idea, and selecting an asset investment ratio distribution method for each investment product to generate the investment portfolio;
(c) a step of validating risk and profitability of the investment portfolio in accordance with a past period and predetermined criteria, and providing generation results and validation results of the investment portfolio to the user terminal; and
(d) a step of setting the investment portfolio to be exposed to another user terminal connected to the server in accordance with a request of the user terminal.

2. The method for generating and validating customized investment portfolios, which is executed by a server, according to claim 1,
wherein prior to the step (a),
an investment idea receiving interface for receiving the investment idea is provided to the user terminal, and
the investment idea is received by the investment idea receiving interface, through any one of an option method of giving options for the investment idea, a text input method of directly inputting a text by the user, and a text input method based on voice recognition through a microphone of the user.

3. The method for generating and validating customized investment portfolios, which is executed by a server, according to claim 2,
wherein when the investment idea receiving interface is implemented through the text input method,
in the step (a),
key words for calculating the investment portfolio are extracted from a plurality of texts input by the user terminal, and whether or not the key words meet predetermined requirements for selecting a country, a type, and an item name of the investment product is determined from the investment idea, and if there are insufficient requirements, the insufficient requirements are provided to the user terminal to receive an additional text.

4. The method for generating and validating customized investment portfolios, which is executed by a server, according to claim 2,
wherein the step (b) includes:
(b-1) a step of searching for the investment product corresponding to the investment idea;
(b-2) a step of removing and filtering the investment product that is determined not to meet the investment idea based on predetermined criteria, among the investment products as a result of the search; and
(b-3) a step of setting the asset investment ratio distribution method for the filtered investment product.

5. The method for generating and validating customized investment portfolios, which is executed by a server, according to claim 4,
wherein in the step (b-1),
predetermined key words for searching for the investment product are extracted from the investment idea and calculating the investment product that matches the key words.

6. The method for generating and validating customized investment portfolios, which is executed by a server, according to claim 4,
wherein in the step (b-2),
the investment product is excluded in which one or more of a divided ratio to a deficit and a profit ratio of equity to a market average of the investment products is lower than a predetermined value.

7. The method for generating and validating customized investment portfolios, which is executed by a server, according to claim 4,
wherein in the step (b-3),
the investment portfolio is completed by setting the asset investment ratio distribution method based on predetermined criteria, among the investment products.

8. The method for generating and validating customized investment portfolios, which is executed by a server, according to claim 4,
wherein in the step (b-3),
a distribution ratio of investment assets that yield an optimal profit ratio, among the investment products included in the investment portfolio, is set through predetermined artificial intelligence.

9. The method for generating and validating customized investment portfolios, which is executed by a server, according to claim 1,
wherein the step (c) includes:
(c-1) a step of quantitatively analyzing the investment portfolio in a past period designated by the user;
(c-2) a step of executing a characteristic analysis of the investment portfolio in accordance with predetermined criteria; and
(c-3) a step of validating the risk and profitability of the investment portfolio.

10. The method for generating and validating customized investment portfolios, which is executed by a server, according to claim 9,
wherein prior to the step (c-1),
the past period for validating the risk and profitability is received from the user terminal, and
wherein in the step (c-1), a quantitative result value is calculated by applying the past period to the investment portfolio.

11. The method for generating and validating customized investment portfolios, which is executed by a server, according to claim 9,
wherein in the step (c-2),
a predetermined result value for the characteristic analysis of the investment portfolio is calculated, and
wherein the predetermined result value uses, as a result value, at least one or more of a value analysis, a profit indicator, a growth indicator, an activity indicator, a safety indicator, a dividend indicator, a price indicator, a separation degree, and a technical analysis indicator of the investment products.

12. The method for generating and validating customized investment portfolios, which is executed by a server, according to claim 9,
wherein in the step (c-3),
the stability and profitability of the investment portfolio are determined to be low when the result of the quantitative analysis calculated in the step (c-1) has a variability of a predetermined value or more, or when the quantitative indicator matching the item of the investment product constituting the investment portfolio is the predetermined value or less.

13. The method for generating and validating customized investment portfolios, which is executed by a server, according to claim 9,
wherein the step (c-1) to step (c-3) are performed regardless of the order or performed simultaneously.

14. The method for generating and validating customized investment portfolios, which is executed by a server, according to claim 1,
wherein prior to the step (d),
personal information of the user further is received from the user terminal, and
wherein in the step (d),
the investment portfolio is shared with another user terminal registered with other personal information having similarity of a predetermined value or less with the personal information, and
wherein the personal information is information including at least one or more of a user's gender, an age, a place of residence, a hobby, interests, a size of assets, an interest investment product, and a type of invested product in the current investment.

15. The method for generating and validating customized investment portfolios, which is executed by a server, according to claim 14,
wherein in the step (d),
a predetermined ratio to costs used for the purchase is provided to the user terminal that registered the investment idea, when the other user terminal purchases the investment portfolio.

16. An apparatus for generating and validating customized investment portfolios, the apparatus comprising:
a memory in which a program for providing a method for generating and validating customized investment portfolios is stored; and
a processor that provides the method for generating and validating customized investment portfolios by executing the program stored in the memory,
wherein the processor is set such that an investment idea a is received from a user terminal; an investment product corresponding to the investment idea is selected, and an asset investment ratio distribution method is selected for each investment product to generate the investment portfolio; and risk and profitability of the portfolio are validated in accordance with a past period and predetermined criteria, and generation results and validation results of the investment portfolio to the user terminal are provided; and the investment portfolio is set to be exposed to another user terminal connected to the server in accordance with a request of the user terminal.

17. A non-transitory computer-readable storage medium storing a program for executing the method for generating and validating customized investment portfolios, the program being executed by the server according to claim 1.
